(19) United States
(12) Patent Application Publication
(10) Pub. No.: US 2022/0327242 A1
(43) Pub. Date: Oct. 13, 2022

(54) DATA MANAGEMENT METHOD AND APPARATUS

(71) Applicant: HUAWEI TECHNOLOGIES CO., LTD., Shenzhen (CN)

(72) Inventor: Bin GAO, Xi?an (CN)

(21) Appl. No.: 17/847,843

(22) Filed: Jun. 23, 2022

Related U.S. Application Data
(63) Continuation of application No. PCT/CN2020/119356, filed on Sep. 30, 2020.

(30) Foreign Application Priority Data
Dec. 30, 2019 (CN) 201911405795.3

(51) Int. Cl. G06F 21/64; G06F 21/62

(52) U.S. Cl. CPC G06F 21/64; G06F 21/6218

(57) ABSTRACT

A data management apparatus determines an association relationship between first service data and first authorization information based on an association relationship between a first source file and the first authorization information, where the first service data is data obtained based on the first source file; and the data management apparatus manages the first service data based on the first authorization information. At least one embodiment is applied to a legal and compliant use scenario of service data after the service data is authorized, and are used to quickly and accurately trace information such as a use scope, a validity period, and a user of the service data. Based on this technology, unauthorized use is effectively limited.

### CROSS-REFERENCE TO RELATED APPLICATIONS

This application is a continuation of International Application No. PCT/CN2020/119356, filed on Sep. 30, 2020, which claims priority to Chinese Patent Application No. 201911405795.3, filed on Dec. 30, 2019. The disclosures of the aforementioned applications are hereby incorporated by reference in their entireties

### BACKGROUND

Countries/organizations impose stricter data security, and legal and compliant use of data (within an authorization scope/authorization period) affects data security. However, there is a lack of a good data tracing method in the industry currently. Identifying a user of data is difficult, whether the data is used in a current region/country, and whether data is deleted after the data expires.

An original file is associated with an authorization scope/authorization period of the original file, and a corresponding authorization scope/authorization period is queried by using the original file.

However, for data derived after original data is parsed, the authorization scope/authorization period of the original file is lost. As a result, accurate legal and compliant use management cannot be performed on the data derived after the original data is parsed.

### SUMMARY

Embodiments described herein provide a data management method and apparatus, to implement trusted data management.

To achieve the foregoing objective, at least one embodiment provides the following technical solutions:

According to a first aspect, a data management method is provided. The method includes: A data management apparatus determines an association relationship between first service data and first authorization information based on an association relationship between a first source file and the first authorization information, where the first service data is data obtained based on the first source file. The data management apparatus manages the first service data based on the first authorization information.

At least one embodiment provides the data management method. In the method, the data management apparatus determines the association relationship between the first service data and the first authorization information based on the association relationship between the first source file and the first authorization information. In this way, authorization information is associated with a service data granularity. Then, the data management apparatus manages the first service data based on the first authorization information associated with the first service data, so that service data is accurately managed. At least one embodiment is applied to a legal and compliant use scenario of service data after the service data is authorized, and is used to quickly and accurately trace information such as a use scope, a validity period, and a user of the service data. Based on this technology, unauthorized use is effectively limited.

In at least one embodiment, the first authorization information includes available time information. Expired data is quickly identified after data authorization expires, to implement refined data destruction.

The first service data in at least one embodiment is data authorized by a user or a platform to a data processor for use, and there is a time limitation on using the first service data. To be specific, a subscriber who subscribes to the first service data uses the first service data in a specific period. The subscriber cannot use the first service data after the period, and the first service data is destroyed.

In at least one embodiment, that the data management apparatus manages the first service data based on the first authorization information includes: The data management apparatus determines, based on the available time information, whether to delete the first service data or configure the first service data to be inaccessible.

In at least one embodiment, that the data management apparatus determines, based on the available time information, whether to delete the first service data or configure the first service data to be inaccessible includes: In response to the data management apparatus determining that a current use time of the first service data is the same as an available time indicated by the available time information, or exceeds the available time indicated by the available time information, the data management apparatus determines to delete the first service data or configure the first service data to be inaccessible.

In at least one embodiment, the current use time of the first service data is the same as the available time indicated by the available time information, or exceeds the available time indicated by the available time information. The method provided in at least one embodiment further includes: The data management apparatus sends first prompt information to the subscriber who subscribes to the first service data, where the first prompt information is used to prompt that the current use time of the first service data is the same as the available time indicated by the available time information, or exceeds the available time indicated by the available time information. In this way, the subscriber who subscribes to the first service data determines a reason why the first service data is inaccessible.

In at least one embodiment, that the data management apparatus determines, based on the available time information, whether to delete the first service data or configure the first service data to be inaccessible includes: In response to the data management apparatus determining that a current use time does not reach an available time indicated by the available time information, the data management apparatus determines not to delete the first service data.

In at least one embodiment, the method provided in at least one embodiment includes: In response to the data management apparatus determining that the current use time of the first service data does not reach the available time indicated by the available time information, the data management apparatus sends second prompt information to the subscriber who subscribes to the first service data, where the second prompt information is used to prompt that the current use time of the first service data does not reach the available time indicated by the available time information. The second prompt information is further used to prompt a device having the first service data to delete the first service data when the use time of the first service data reaches the available time.

In at least one embodiment, the first authorization information includes use permission information. In this way, in a subsequent migration process of the first service data, the use permission information of the first service data is compared with a target location to which the service data is to be transferred, and service data beyond a use permission scope is filtered, to avoid unauthorized cross-border transfer of the first service data. This technology accurately verifies and filters a piece of data, to make data transfer verification more accurate.

In at least one embodiment, that the data management apparatus manages the first service data based on the first authorization information includes: The data management apparatus determines, based on the use permission information, whether to send the first service data to the target location.

In at least one embodiment, that the data management apparatus determines, based on the use permission information, whether to send the first service data to the target location includes: In response to the use permission information not including the target location, the data management apparatus rejects sending the first service data to the target location. This prevents the service data from being migrated to an unauthorized location. Rejecting sending the first service data to the target location is understood as filtering out the first service data in a process of migrating the first service data to the target location.

In at least one embodiment, that the data management apparatus determines, based on the use permission information, whether to send the first service data to the target location includes: In response to the use permission information including the target location, the data management apparatus allows sending the first service data to the target location.

In at least one embodiment, the method further includes: The data management apparatus establishes an association relationship between the first service data and information about a data processor of the first service data. In this way, the information about the data processor who processes the first service data is determined. The data processors who process the service data is queried and a data processing process is traced.

In at least one embodiment, the information about the data processor includes one or more of the following: a parser identifier, a parser name, a parser version number, a data type, or remark information.

In at least one embodiment, the method further includes: The data management apparatus establishes an association relationship between the first service data and information about the subscriber of the first service data. In this way, the information about the subscriber who subscribes to the first service data is determined.

In at least one embodiment, the method further includes: The data management apparatus receives subscription information, where the subscription information carries an identifier of the first service data and the information about the subscriber of the first service data. The data management apparatus establishes the association relationship between the first service data and the information about the subscriber of the first service data based on the subscription information.

In at least one embodiment, the first authorization information further includes basic information about an authorizer (for example, a country, a region, a city, and a name of the authorizer).

According to a second aspect, at least one embodiment provides a data management apparatus. The data management apparatus is a management device, or is a chip or a chip system in the management device. The data management apparatus includes a processing unit and a communication unit. When the data management apparatus is the management device, the processing unit is a processor, and the communication unit is a communication interface or an interface circuit. The data management apparatus further includes a storage unit, and the storage unit is a memory. The storage unit is configured to store instructions, and the processing unit executes the instructions stored in the storage unit, so that the data management apparatus implements the data management method described in any one of the first aspect.

The data management apparatus includes the processing unit. The processing unit is configured to determine an association relationship between first service data and first authorization information based on an association relationship between a first source file and the first authorization information, where the first service data is data obtained based on the first source file. The processing unit is further configured to manage the first service data based on the first authorization information.

In at least one embodiment, the first authorization information includes available time information.

The first service data in at least one embodiment is data authorized by a user or a platform to a data processor for use, and there is a time limitation on using the first service data. To be specific, a subscriber who subscribes to the first service data uses the first service data in a specific period. The subscriber cannot use the first service data after the period, and the first service data is destroyed.

In at least one embodiment, the processing unit is specifically configured to determine, based on the available time information, whether to delete the first service data or configure the first service data to be inaccessible.

In at least one embodiment, the processing unit is specifically configured to: if determining that a current use time of the first service data is the same as an available time indicated by the available time information, or exceeds the available time indicated by the available time information, the data management apparatus determines to delete the first service data or configure the first service data to be inaccessible.

In at least one embodiment, the current use time of the first service data is the same as the available time indicated by the available time information, or exceeds the available time indicated by the available time information. The communication unit is configured to send first prompt information to the subscriber who subscribes to the first service data, where the first prompt information is used to prompt that the current use time of the first service data is the same as the available time indicated by the available time information, or exceeds the available time indicated by the available time information.

In at least one embodiment, the processing unit is specifically configured to: if determining that a current use time does not reach an available time indicated by the available time information, determine not to delete the first service data.

In at least one embodiment, the processing unit is configured to: if determining that the current use time of the first service data does not reach the available time indicated by the available time information, the processing unit sends, through the communication unit, second prompt information to the subscriber who subscribes to the first service data, where the second prompt information is used to prompt that the current use time of the first service data does not reach the available time indicated by the available time information. The second prompt information is further used to prompt a device having the first service data to delete the first service data when the use time of the first service data reaches the available time.

In at least one embodiment, the first authorization information includes use permission information.

In at least one embodiment, the processing unit is specifically configured to determine, based on the use permission information, whether to send the first service data to a target location.

In at least one embodiment, if the use permission information does not include the target location, the processing unit is configured to reject sending the first service data to the target location. This prevents the service data from being migrated to an unauthorized location.

In at least one embodiment, if the use permission information includes the target location, the processing unit is configured to allow sending the first service data to the target location.

In at least one embodiment, the processing unit is further configured to establish an association relationship between the first service data and information about a data processor of the first service data.

In at least one embodiment, the information about the data processor includes one or more of the following: a parser identifier, a parser name, a parser version number, a data type, or remark information.

In at least one embodiment, the communication unit is further configured to receive subscription information, where the subscription information carries an identifier of the first service data and information about the subscriber of the first service data. The data management apparatus establishes an association relationship between the first service data and information about the subscriber of the first service data based on the subscription information.

In at least one embodiment, the first authorization information further includes basic information about an authorizer (for example, a country, a region, a city, and a name of the authorizer).

For example, when the data management apparatus is the chip or the chip system, the processing unit is a processor, and the communication unit is a communication interface. For example, the communication interface is an input/output interface, a pin, a circuit, or the like. The processing unit executes instructions stored in a storage unit, so that the data management apparatus implements the data management method described in any one of the first aspect or the first aspect. The storage unit is a storage unit (for example, a register or a cache) in the chip, or is a storage unit (for example, a read-only memory or a random access memory) that is outside the chip and that is in the data management apparatus.

According to a third aspect, at least one embodiment provides a computer-readable storage medium. The computer-readable storage medium stores a computer program or instructions. When the computer program or the instructions is/are run on a computer, the computer is enabled to perform the data management method described in any one of the first aspect.

According to a fourth aspect, at least one embodiment provides a computer program product including instructions. When the instructions are run on a computer, the computer is enabled to perform the data management method described in the first aspect.

According to a fifth aspect, at least one embodiment provides a data management apparatus. The data management apparatus includes a processor and a storage medium. The storage medium stores instructions. When the instructions are run by the processor, the data management method described in the first aspect.

According to a sixth aspect, at least one embodiment provides a chip or a chip system. The chip or the chip system includes at least one processor and a communication interface. The communication interface and the at least one processor are interconnected through a line. The at least one processor is configured to run a computer program or instructions, to perform the data management method described in any one of the first aspect.

According to a seventh aspect, at least one embodiment provides a data management apparatus. The data management apparatus includes a processor and a memory that stores a computer-readable storage medium. The processor runs the computer-readable storage medium stored in the memory, to implement the data management method described in the first aspect.

For beneficial effects of the second aspect to the seventh aspect and the implementations of the second aspect to the seventh aspect according to at least one embodiment, refer to analysis of beneficial effects in the first aspect and the implementations of the first aspect. Details are not described herein again.

### BRIEF DESCRIPTION OF DRAWINGS

FIG. 1 is a schematic flowchart of a data management method according to at least one embodiment;

FIG. 2 is a processing flowchart of a data management method according to at least one embodiment;

FIG. 3 is another schematic flowchart of a data management method according to at least one embodiment;

FIG. 4 is a schematic diagram of a structure of a data management apparatus according to at least one embodiment;

FIG. 5 is another schematic diagram of a structure of a data management apparatus according to at least one embodiment;

FIG. 6 is a schematic diagram of a structure of a management device according to at least one embodiment; and

FIG. 7 is a schematic diagram of a structure of a chip according to at least one embodiment.

### DESCRIPTION OF EMBODIMENTS

To clearly describe technical solutions in embodiments described herein, words such as “first” and “second” are used to distinguish between same items or similar items that have basically same functions and purposes. For example, first service data and second service data are merely used to distinguish different service data, and a sequence of the first service data and the second service data is not limited. A person skilled in the art understands that the words such as “first” and “second” do not limit a quantity or an execution sequence, and the words such as “first” and “second” do not indicate a definite difference.

As used herein, a word such as “example” or “for example” is used to represent giving an example, an illustration, or a description. Any embodiment or design scheme described as an “example” or “for example” is not explained as being more preferred or having more advantages than another embodiment or design scheme. Exactly, use of the word such as “example” or “for example” is intended to present a related concept in a specific manner.

In at least one embodiment, “at least one” refers to one or more, and “a plurality of” refers to two or more. “And/or” describes an association relationship between associated objects, and indicates that three relationships exists. For example, A and/or B indicates the following cases: Only A exists, both A and B exist, and only B exists, where A and B is singular or plural. The character “/” generally indicates an “or” relationship between the associated objects. “At least one of the following items (pieces)” or a similar expression thereof means any combination of these items, including any combination of singular items (pieces) or plural items (pieces). For example, at least one (piece) of a, b, or c represents: a, b, c; a and b; a and c; b and c; or a, b, and c; where a, b, and c is singular or plural.

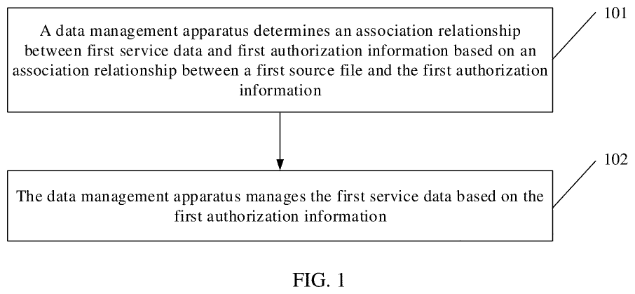

FIG. 1 shows a data management method according to at least one embodiment. The method includes the following steps.

101: A data management apparatus determines an association relationship between first service data and first authorization information based on an association relationship between a first source file and the first authorization information.

The first service data is data obtained based on the first source file.

In at least one embodiment, the association relationship between the first service data and the first authorization information are established by the data management apparatus, or is sent to the data management apparatus after another apparatus establishes the association relationship between the first service data and the first authorization information. This is not limited in at least one embodiment.

In at least one embodiment, the first service data is obtained by performing data parsing on the corresponding first source file. That is, the first source file is an original file of the first service data, and the first service data is obtained by parsing the first source file according to a specific service rule by the data management apparatus or the another apparatus.

For example, the first source file is identity card information (including a name, an identity card number, an address, and a date of birth) of a user. After the first source file is parsed, the obtained first service data is [the name, the identity card number, the address, and the date of birth]; is [the name and the identity card number]; or is [the name and the date of birth].

Generally, the first source file is authorized to a data processor. Therefore, authorization information of one or more pieces of service data obtained by parsing the same first source file is inherited from the first source file, and a plurality of pieces of service data obtained by parsing the same source file have the same authorization information.

The user or a platform storing the first source file authorizes the first source file to the data management apparatus. For example, the data management apparatus is a data management apparatus in an operator. The operator includes a device managing the first service data, or includes a device storing the first service data.

In at least one embodiment, the first service data represents one or more of n pieces of service data.

102: The data management apparatus manages the first service data based on the first authorization information.

At least one embodiment provides the data management method. In the method, the data management apparatus determines the association relationship between the first service data and the first authorization information based on the association relationship between the first source file and the first authorization information. In this way, authorization information is associated with a service data granularity. Then, the data management apparatus manages the first service data based on the first authorization information associated with the first service data, so that service data is accurately managed. This embodiment is applied to a legal and compliant use scenario of service data after the service data is authorized, and is used to quickly and accurately trace information such as a use scope, a validity period, and a user of the service data. Based on this technology, unauthorized use is effectively limited.

In at least one embodiment, step 101 is implemented in the following manners:

(a) The data management apparatus obtains an authorization information table, where the authorization information table includes at least one piece of authorization information (for example, the first authorization information). The authorization information table includes the at least one piece of authorization information and an identifier of authorization information. Specific content of the authorization information table is shown in Table 1.

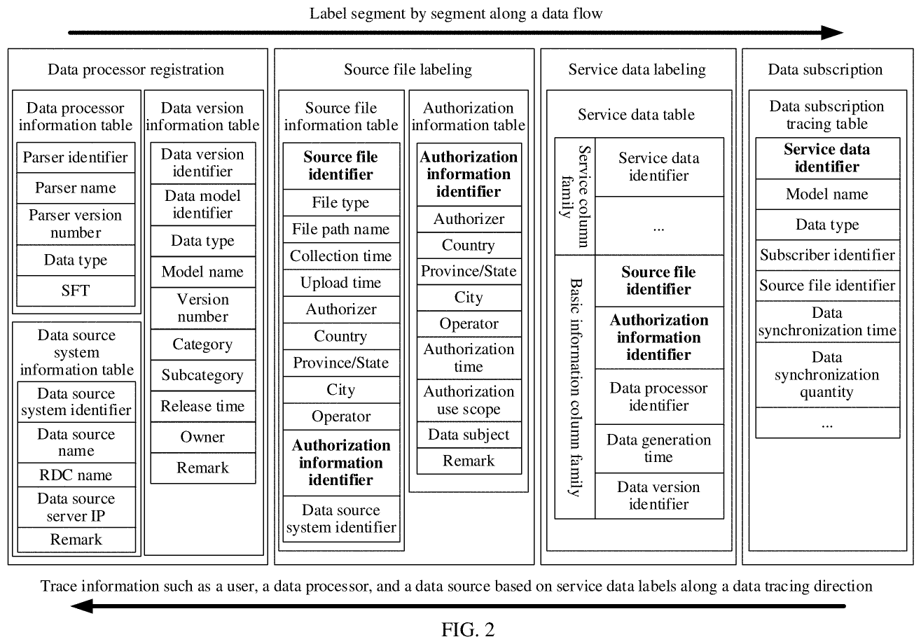

For example, as shown in FIG. 2, the first authorization information in at least one embodiment includes available time information (which is also referred to as an authorization use time or an authorization expiration time) and/or use permission information. Further, as shown in FIG. 2, the first authorization information further includes an authorization identifier and basic information about an authorizer. For example, the basic information about the authorizer includes a country, a region (province/state), a city, and a name of the authorizer. Specifically, Table 1 shows specific content of the authorization information.

TABLE 1
Specific content of the first authorization information
Authorization information identifier
Country
Province/State
City
Authorizer
Available time information
Use permission information
Authorization destination
Data subject
Remark

The available time information is used to reflect a period or a time period in which the service data is legally used. The available time information is determined by using a start time and an end time, or the available time information is determined by using a start time and a specified time period, or the available time information is determined by using an end time.

The use permission information is used to limit a country, a region (province and city), a platform, and a function in which the service data is legally used.

For example, the platform includes a payment platform, a communication platform, a social platform, an online banking platform, and a shopping platform.

For example, the first service data is the identity card number of the user, and a use permission indicated by the first authorization information is to apply for a telephone card. If the identity card number of the user is used to apply for the telephone card, the first service data is within the use permission described in the use permission information. In response to the identity card number of the user being used to perform a service other than applying for the telephone card, the first service data is indicated as not being within the use permission described in the use permission information.

For example, the first service data is identity information (including but not limited to a name, a certificate type, a certificate number, a domicile, a mobile phone number, and payment account information) of the user, and a function indicated by the first authorization information is to issue a bank card of an XX bank for the user. If the identity information of the user is used to issue the bank card of the XX bank for the user, the first service data is within the use permission described in the use permission information. In response to the identity card number of the user being used to perform a service other than issuing the bank card of the XX bank for the user, the first service data is not indicated as being within the use permission described in the use permission information.

(b) The data management apparatus adds an authorization label to the first source file. That is, the data management apparatus establishes a mapping relationship between the first source file and the authorization information table. In this way, the authorizer, a use permission scope, and the available time information of the first source file is subsequently queried based on an identifier of the first source file. In addition, in response to there being a mapping relationship between a plurality of source files including the first source file and the authorization information table, source files whose validity period expires are also queried based on the available time information.

(c) The data management apparatus performs data parsing and processing on the first source file, and adds a data processor label and an authorization information table label after the parsing is completed, that is, establishes a relationship between parsed result data and the data processor, and establishes a relationship table between the result data and the authorization information. A specific processor who processes the service data, a specific authorizer, an authorization scope, and an authorization expiration time of the service data is easily queried based on a service data identifier at a fine granularity. In addition, related result data is queried based on the authorization expiration time.

As shown in FIG. 2, the data management apparatus labels the service data. The service data labeling means that the data management apparatus establishes a service data table shown in FIG. 2. The service data table includes the service data identifier and a basic information column family. The basic information column family includes information such as a source file identifier, a data processor identifier, a data generation time, and a data version number.

That is, the identifier of the first source file corresponding to the first service data is carried in the first service data.

Table 2 shows a data structure of the first service data.

TABLE 2
Data structure of the first service data

| Service-related | | | | | | | |
|---|---|---|---|---|---|---|---|
| column family | | | Data label information column family | | | | |
| Service data | . . . | . . . | Identifier of the | Authorization | Information | Data | . . . |
| identifier | | | first source file | information | about the data | generation | |
| | | | | identifier | processor | time | |

In at least one embodiment, a manner in which the data management apparatus labels the first service data includes but is not limited to adding a label column to a database or forming an independent data label file.

The independent data label file means that an added data label and the service data are not stored in a same table or same space, and the added data label is stored as an independent file.

In at least one embodiment, the data management apparatus establishes an association relationship between any one of the n pieces of service data and authorization information of a corresponding source file. A manner in which the data management apparatus determines the association relationship between the n pieces of service data and the authorization information of the corresponding source file is the same as a manner in which the data management apparatus determines the association relationship between the first service data and the first authorization information. Therefore, in at least one embodiment, an example in which the data management apparatus determines the association relationship between the first service data and the first authorization information is used, and there is no indicative meaning.

Authorization information associated with different service data in the n pieces of service data is different, where n is a positive integer. The n pieces of service data is service data obtained by parsing different source files, or is service data obtained by parsing a same source file.

This is not limited in at least one embodiment.

In at least one embodiment, authorization information associated with different service data is the same or is different. This is not limited in at least one embodiment.

That authorization information associated with different service data is different means that available time information and use permission information associated with the different service data are both different. For example, available time information associated with service data 1 is a time 2, and use permission information associated with the service data 1 is an area A. Available time information associated with service data 2 is a time 1, and use permission information associated with the service data 2 is an area B.

That authorization information associated with different service data is different means that available time information associated with the different service data is the same, but use permission information associated with the different service data is different. For example, available time information associated with service data 1 and service data 2 is a time 2, but use permission information of the service data 1 is an area A and use permission information of the service data 2 is an area B.

That authorization information associated with different service data is different means that available time information associated with the different service data is different, but use permission information associated with the different service data is the same. For example, use permission information associated with service data 1 and service data 2 is an area B, but available time information of the service data 1 is a time 1 and available time information of the service data 2 is a time 2.

In a possible embodiment, for example, the first authorization information includes the available time information. Correspondingly, at least one embodiment is implemented in the following manner. The data management apparatus determines, based on the available time information, whether to delete the first service data or configure the first service data to be inaccessible.

In a possible implementation, that the data management apparatus determines, based on the available time information, whether to delete the first service data or configure the first service data to be inaccessible is implemented in the following manner. In response to the data management apparatus determining that a current use time of the first service data is the same as an available time indicated by the available time information, or exceeds the available time indicated by the available time information, the data management apparatus determines to delete the first service data or configure the first service data to be inaccessible.

For example, in response to the current use time being Dec. 30, 2019, and the available time indicated by the available time information being Dec. 30, 2019, the data management apparatus determines to delete the first service data or configure the first service data to be inaccessible.

In the available time information, a time unit is any one of a second, a minute, a year, a month, or a day. This is not limited in this embodiment of this application.

In at least one embodiment, the current use time of the first service data is the same as the available time indicated by the available time information, or exceeds the available time indicated by the available time information. The method provided in this embodiment of this application further includes: The data management apparatus sends first prompt information to a subscriber who subscribes to the first service data, where the first prompt information is used to prompt that the current use time of the first service data is the same as the available time indicated by the available time information, or exceeds the available time indicated by the available time information. In this way, the subscriber who subscribes to the first service data determines a reason why the first service data is inaccessible.

In at least one embodiment, that the data management apparatus determines, based on the available time information, whether to delete the first service data or configure the first service data to be inaccessible includes: in response to the data management apparatus determining that a current use time does not reach an available time indicated by the available time information, the data management apparatus determines not to delete the first service data, or determines to configure the first service data to be accessible and marks the available time until which the first service data is accessed. In this way, the subscriber learns of the available time of the first service data in a timely manner, and re-subscribe to the first service data before the available time of the first service data arrives.

In at least one embodiment, the method provided in this embodiment of this application includes: In response to the data management apparatus determining that the current use time of the first service data does not reach the available time indicated by the available time information, the data management apparatus sends second prompt information to a subscriber who subscribes to the first service data, where the second prompt information is used to prompt that the current use time of the first service data does not reach the available time indicated by the available time information. The second prompt information is further used to prompt a device having the first service data to delete the first service data when the use time of the first service data reaches the available time.

Whether to delete the first service data or configure the first service data to be inaccessible is determined based on the available time information. In this way, the first service data is processed in a timely manner, to implement accurate data tracing of data and data life cycle management at a fine granularity.

In at least one embodiment, the data management apparatus determines, based on the first authorization information associated with the first service data, whether the first service data is service data that is about to expire or expired service data.

The “service data that is about to expire” means that a current use time of the service data is earlier than an available time of the service data, and a difference between the current use time and the available time of the service data is less than a preset value. For example, a current use time of service data A is Dec. 3, 2019, and an available time of the service data A is Nov. 1, 2019 to Dec. 5, 2019. Because a time difference between Dec. 3, 2019 and Dec. 5, 2019 is two days and is less than the preset value, the service data A is the service data that is about to expire. In this embodiment of this application, the service data that is about to expire is calculated in years, months, days, hours, or minutes. For example, in response to a current use time of service data being one hour earlier than the available time information, the service data is considered as the service data that is about to expire.

In at least one embodiment, the “expired service data” means that the current use time of the service data exceeds the available time of the service data or is the same as the available time of the service data. That the current use time of the service data exceeds the available time of the service data means that the current use time of the service data is later than the available time of the service data.

In at least one embodiment, the first service data is the expired service data, and the second prompt information is further used to prompt the device having the first service data to delete the first service data. Alternatively, the first service data is the service data that is about to expire, and the second prompt information is further used to prompt that when the use time of the first service data reaches the authorization use time, the device having the first service data deletes the first service data.

For the service data that is about to expire, the data management apparatus configures the service data to be in an accessible state. For the expired service data, the data management apparatus configures the expired service data to be inaccessible or delete the expired service data.

In at least one embodiment, for example, the authorization information is the use permission information. Correspondingly, at least one embodiment is implemented in the following manner. The data management apparatus determines, based on the use permission information, whether to send the first service data to a target location.

The use permission information is used to limit a use scope or a migration scope of the first service data.

In at least one embodiment, that the data management apparatus determines, based on the use permission information, whether to send the first service data to a target location includes: In response to the use permission information not including the target location, the data management apparatus rejects sending the first service data to the target location. This prevents the service data from being migrated to an unauthorized location. Rejecting sending the first service data to the target location is understood as filtering out the first service data in a process of migrating the first service data to the target location.

For example, the first service data is service data a. A use permission described in use permission information of the service data a is in an area A. In response to the service data a being be used in an area B or migrated to the area B in a subsequent process, the data management apparatus rejects the migration operation when the service data a is migrated to the area B. Alternatively, when a plurality of pieces of service data including the service data a need to be migrated to the area B, and the use permission of the service data a is not in the area B, the data management apparatus filters out the service data a.

In at least one embodiment, that the data management apparatus determines, based on the use permission information, whether to send the first service data to a target location includes: In response to the use permission information including the target location, the data management apparatus allows sending the first service data to the target location.

In at least one embodiment, the data management apparatus manages the first service data based on the first authorization information and further includes: The data management apparatus updates the first authorization information of the first service data.

For example, the data management apparatus extends or advance the available time of the first service data or change the use permission information of the first service data. For example, a use area of the first service data is changed from the area A to the area B. Specifically, in response to the authorization information of the first source file of the first service data being changed, the data management apparatus updates the first authorization information of the first service data based on updated authorization information of the first source file. Certainly, alternatively, the data management apparatus independently determines to extend or advance the available time of the first service data or change the use permission information of the first service data.

Generally, to enable the subscriber to effectively use the first service data, in response to the data management apparatus receiving a subscription request of the subscriber before the first service data is about to reach the available time described in the available time information, where the subscription request indicates that a subscription time of the first service data needs to be extended, the data management apparatus determines to extend the available time of the first service data.

In response to one piece of first service data being subscribed to by a plurality of subscribers, and a subscriber subscribing to the first service data and requesting extension, the data management apparatus extends the available time of the first service data subscribed to by the subscriber a. In response to a subscriber b subscribing to the same piece of first service data, an available period of the first service data subscribed to by the subscriber b remains unchanged.

In conclusion, the data management apparatus establishes a mapping relationship between the n pieces of service data and a corresponding associated source file. However, authorization information associated with different service data in the n pieces of service data is different. When the service data is managed, the first service data that needs to be managed is selected from the n pieces of service data. Therefore, in at least one embodiment, the method further includes: The data management apparatus determines the first service data from then pieces of service data based on at least one piece of authorization information.

In at least one embodiment, the data management apparatus determines the first service data from the n pieces of service data based on the at least one piece of authorization information through the following process 1 and process 2 or the following process 3 and process 4.

Process 1: The data management apparatus obtains target authorization information from the at least one piece of authorization information, where an authorization use time indicated by the target authorization information is about to reach a first time or has exceeded the first time.

The first time is a preset time or a system time.

The data management apparatus has an authorization information table including one or more pieces of authorization information. The data management apparatus periodically scans the authorization information table at a preset periodicity, compare an authorization use time indicated by authorization information in the authorization information table with the system time, and select authorization information that is about to expire or expired authorization information.

Process 2: The data management apparatus determines service data that is in the n pieces of service data and that has the target authorization information as the first service data. In other words, the first authorization information associated with the first service data is the same as the target authorization information.

For example, as shown in Table 2, the authorization information table of the data management apparatus includes authorization information 1 to authorization information 3, and an authorization use time corresponding to authorization information is shown in Table 3.

TABLE 3
Authorization information table

| | Authorization | |
|---|---|---|
| Authorization information | use time | System time |
| Authorization information 1 | Dec. 31, 2019 | Dec. 3, 2019 |
| Authorization information 2 | Dec. 18, 2019 | Dec. 3, 2019 |
| Authorization information 3 | Dec. 3, 2019 | Dec. 3, 2019 |

The data management apparatus determines, by scanning the authorization information table shown in Table 3 and comparing the authorization use time of authorization information and the system time, that the authorization information 3 is the expired authorization information and the authorization information 2 is the authorization information that is about to expire. Then, in response to authorization information carried in the service data A being the authorization information 3, the data management apparatus determines that the service data A is the first service data.

In at least one embodiment, the data management apparatus determines the first service data from the n pieces of service data based on the at least one piece of authorization information in the following manners:

Process 3: The data management apparatus determines the available time information of service data based on the authorization information associated with the n pieces of service data.

Process 4: The data management apparatus determines, as the first service data, service data that is about to reach a first time or that has exceeded the first time and that is in the available time information corresponding to the n pieces of service data.

For example, the first time is a system time. For example, as shown in Table 4, the n pieces of service data include service data 1 to service data 3, and an authorization use time of service data is shown in Table 4.

TABLE 4
Service data

| | Available time | |
|---|---|---|
| Service data | information | System time |
| Service data 1 | Dec. 31, 2019 | Dec. 3, 2019 |
| Service data 2 | Dec. 18, 2019 | Dec. 3, 2019 |
| Service data 3 | Dec. 3, 2019 | Dec. 3, 2019 |

The data management apparatus determines, by scanning the n pieces of service data and comparing the available time information of service data and the system time, that the service data 3 is the expired service data and the service data 2 is the service data that is about to expire. Therefore, the data management apparatus determines that the first service data is the service data 3.

In at least one embodiment, as shown in FIG. 2, the method provided in at least one embodiment further includes: The data management apparatus establishes a mapping relationship between the first service data and information about the data processor. In this way, processing steps that are performed on the first service data is quickly retrieved, and data processors who process the first service data is directly queried, to facilitate tracing of a data processing process.

For example, the information about the data processor includes one or more of a parser identifier, a parser name, a parser version number, and a data type. In addition, the information about the data processor further includes data version information. For example, a data version includes one or more of a data version identifier, a data model identifier, a data type, a model name, a version number, a category, a subcategory, a release time, and an owner. In addition, the information about the data processor further includes a data source system information table, used to identify a data source system from which the source file is sourced. For example, the data source system table includes a data source system identifier and one or more of the following information: a data source name, a regional data center (Regional Data Center, RDC) name, a data source server IP, and remark information. An RDC indicates that data is to be stored in an authorized region or country.

In at least one embodiment, as shown in FIG. 2, the method provided in at least one embodiment further includes: The data management apparatus establishes a mapping relationship between the first service data and information about the subscriber who subscribes to the first service data. In this way, a subscriber who uses the first service data is traced.

For example, the information about the subscriber includes a service data identifier, and one or more of the following information: a model name, a data type, a subscriber identifier, a source file identifier, a data synchronization time, and a data synchronization quantity.

For a plurality of service data, a mapping relationship between the plurality of pieces of service data and information about a subscriber of service data is established. In this way, in response to a subscriber A who subsequently uses the service data being different from a subscriber associated with the service data, the data management apparatus disallows the subscriber A from using the service data. In response to a subscriber who subsequently subscribes to the service data being the same as the subscriber associated with the service data, the subscriber who subscribes to the service data has a permission to use the service data.

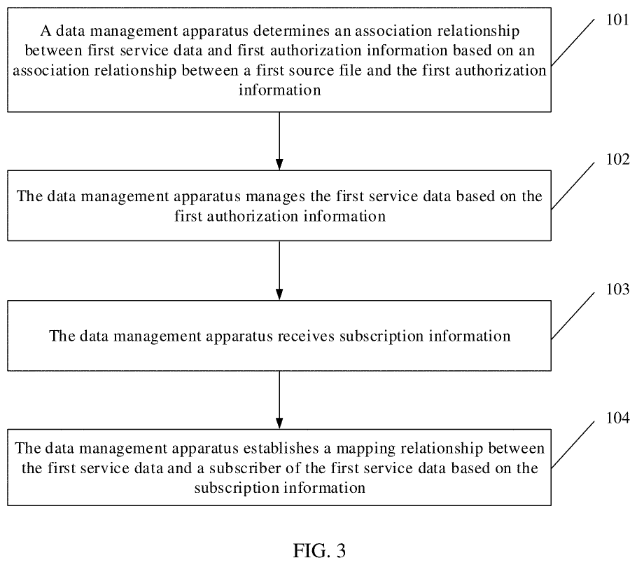

In at least one embodiment, as shown in FIG. 3, the method provided in at least one embodiment further includes the following steps.

103: The data management apparatus receives subscription information, where the subscription information carries an identifier of the first service data and the information about the subscriber of the first service data, and the first service data is any one of the n pieces of service data.

104: The data management apparatus establishes a mapping relationship between the first service data and the subscriber of the first service data based on the subscription information.

A mapping relationship between service data and the subscriber of service data is established in a same manner. Therefore, in at least one embodiment, the first service data is used as an example to describe how to establish the mapping relationship between service data and the subscriber of service data.

The foregoing mainly describes the solution in at least one embodiment from the perspective of interaction between network elements. To implement the foregoing functions, a network element such as a data management apparatus includes corresponding hardware structures and/or software modules for implementing the functions. A person skilled in the art is easily aware that, in combination with units and algorithm steps disclosed herein, at least one embodiment is implemented by hardware or a combination of hardware and computer software. Whether a function is performed by hardware or hardware driven by computer software depends on particular applications and design constraints of the technical solutions. A person skilled in the art uses different methods to implement the described functions, but the implementation does not go beyond the scope of embodiments described herein.

In at least one embodiment, the data management apparatus is divided into function units based on the foregoing the method examples. For example, function units is divided based on corresponding functions, or two or more than two functions is integrated into one processing unit. The integrated unit is implemented in a form of hardware, or is implemented in a form of a software function unit. In at least one embodiment, division into units is an example, and is merely a logical function division. There is another division manner.

The foregoing describes the method of at least one embodiment with reference to FIG. 1 to FIG. 3. The following describes a data management apparatus that performs the foregoing method and that is provided in at least one embodiment. A person skilled in the art understands that the method and the apparatus are mutually combined and referenced, and a data management apparatus perform steps in the foregoing data management method.

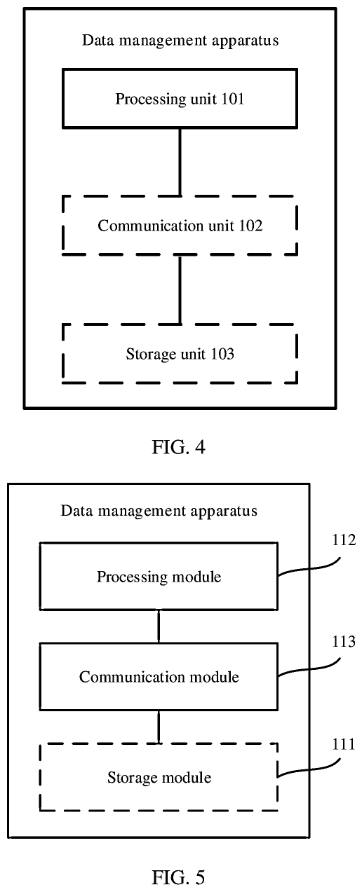

When an integrated unit is used, FIG. 4 shows the data management apparatus in at least one embodiment. The data management apparatus includes a processing unit 101.

The processing unit 101 is configured to support the data management apparatus in performing step 101 and step 102 in at least one embodiment.

In at least one embodiment, the data management apparatus includes: a communication unit 102 and a storage unit 103. The storage unit 103 is configured to store a mapping relationship between first service data and first authorization information, store a mapping relationship between a first source file and the first authorization information, store a mapping relationship between the first service data and information about a subscriber who subscribes to the first service data, and store a mapping relationship between the first service data and information about a data processor. The communication unit 102 is configured to support the data management apparatus in performing step 103 in the foregoing embodiment.

In at least one embodiment, the processing unit 101 is configured to support the data management apparatus in performing step 104 in the foregoing embodiment.

When an integrated unit is used, FIG. 5 shows a schematic diagram of a possible logical structure of the data management apparatus in the foregoing embodiment. The data management apparatus includes a processing module 112. The processing module 112 is configured to control and manage an action of the data management apparatus. For example, the processing module 112 is configured to perform an information/data processing step performed by the data management apparatus.

In at least one embodiment, the data management apparatus further includes a communication module 113, configured to support the data management apparatus in performing an information/data sending or receiving step.

In at least one embodiment, the data management apparatus further includes a storage module 111, configured to store program code and data of the data management apparatus. For example, the storage module 111 is configured to store a mapping relationship between first service data and first authorization information, a mapping relationship between a first source file and the first authorization information, a mapping relationship between the first service data and information about a subscriber who subscribes to the first service data, and a mapping relationship between the first service data and information about a data processor.

The processing module 112 is configured to support the data management apparatus in performing step 101 and step 102 in the foregoing embodiment.

In at least one embodiment, the processing module 112 is configured to support the data management apparatus in performing step 104 in the foregoing embodiment.

In at least one embodiment, the data management apparatus further includes a communication module 113, configured to support the data management apparatus in performing step 103 in the foregoing embodiment.

The processing module 112 is a processor or a controller, for example, is a central processing unit, a general-purpose processor, a digital signal processor, an application-specific integrated circuit, a field programmable gate array or another programmable logic device, a transistor logic device, a hardware component, or any combination thereof. The processor implements or executes various examples of logical blocks, modules, and circuits described with reference to the content disclosed in at least one embodiment. Alternatively, the processor is a combination of processors implementing a computing function, for example, a combination of one or more microprocessors, or a combination of a digital signal processor and a microprocessor. The communication module 113 is a transceiver, a transceiver circuit, a communication interface, or the like. The storage module 111 is a memory.

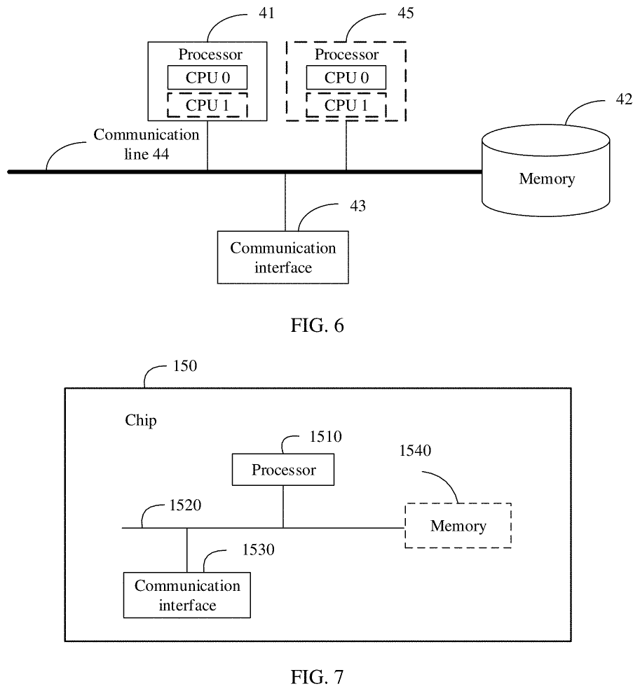

When the processing module 112 is a processor 41 or a processor 45, the communication module 113 is a communication interface 43, and the storage module 111 is a memory 42, the data management apparatus in at least one embodiment is a management device shown in FIG. 6.

FIG. 6 is a schematic diagram of a structure of a management device according to at least one embodiment. For a structure of the data management apparatus, refer to the structure shown in FIG. 6. The management device includes the processor 41, a communication line 44, and at least one communication interface (FIG. 6 is described merely by using an example in which the management device includes the communication interface 43).

Optionally, the management device further includes the memory 42.

The processor 41 is a general-purpose central processing unit (central processing unit, CPU), a microprocessor, an application-specific integrated circuit (application-specific integrated circuit, ASIC), or one or more integrated circuits configured to control program execution of the solutions described herein in at least one embodiment.

The communication line 44 includes a path for transferring information between the foregoing components.

The communication interface 43 is configured to communicate with another device or a communication network such as the Ethernet, a radio access network (radio access network, RAN), or a wireless local area network (wireless local area network, WLAN) by using any apparatus such as a transceiver.

The memory 42 is a read-only memory (read-only memory, ROM) or another type of static storage device that stores static information and instructions, or a random access memory (random access memory, RAM) or another type of dynamic storage device that stores information and instructions, or is an electrically erasable programmable read-only memory (electrically erasable programmable read-only memory, EEPROM), a compact disc read-only memory (compact disc read-only memory, CD-ROM) or another compact disc storage, an optical disc storage (including a compressed optical disc, a laser disc, an optical disc, a digital versatile disc, a Blu-ray disc, or the like), a magnetic disk storage medium or another magnetic storage device, or any other medium that is used to carry or store expected program code in a form of instructions or a data structure and that is accessed by a computer, but is not limited thereto. The memory exists independently, and is connected to the processor through the communication line 44. The memory alternatively is integrated with the processor.

The memory 42 is configured to store computer-executable instructions for performing the solutions according to at least one embodiment, and the processor 41 controls execution of the computer-executable instructions. The processor 41 is configured to execute the computer-executable instructions stored in the memory 42, to implement the data management method provided in at least one embodiment.

Optionally, the computer-executable instructions are also referred to as application program code. This is not specifically limited in this embodiment of this application.

In at least one embodiment, the processor 41 includes one or more CPUs, such as a CPU 0 and a CPU 1 in FIG. 6.

In at least one embodiment, the management device may include a plurality of processors, such as the processor 41 and a processor 45 in FIG. 6. The processors are a single-core (single-CPU) processor or a multi-core (multi-CPU) processor. The processor herein is one or more devices, circuits, and/or processing cores configured to process data (for example, computer program instructions).

FIG. 7 is a schematic diagram of a structure of a chip 150 according to at least one embodiment. The chip 150 includes one or more (including two) processors 1510 and a communication interface 1530.

Optionally, the chip 150 further includes a memory 1540. The memory 1540 includes a read-only memory and a random access memory, and provide operation instructions and data for the processor 1510. A part of the memory 1540 further includes a non-volatile random access memory (non-volatile random access memory, NVRAM).

In at least one embodiment, the memory 1540 stores the following element: an executable module or a data structure, a subset thereof, or an extended set thereof.

In at least one embodiment, the operation instructions stored in the memory 1540 (where the operation instructions is stored in an operating system) are invoked to perform a corresponding operation.

In at least one embodiment, a data management apparatus is provided.

The processor 1510 controls a processing operation of a data management apparatus, and the processor 1510 is also referred to as a central processing unit (central processing unit, CPU).

The memory 1540 includes a read-only memory and a random access memory, and provide instructions and data for the processor 1510. A part of the memory 1540 further includes an NVRAM. For example, in at least one embodiment, the memory 1540, the communication interface 1530, and the memory 1540 are coupled together through a bus system 1520. The bus system 1520 further includes a power bus, a control bus, a status signal bus, and the like in addition to a data bus. However, for clear description, various buses are marked as the bus system 1520 in FIG. 7.

The method disclosed in at least one embodiment is applied to the processor 1510, or is implemented by the processor 1510. The processor 1510 is an integrated circuit chip and has a signal processing capability. In a process of at least one embodiment, the steps in the foregoing method is implemented by using a hardware integrated logical circuit in the processor 1510, or by using instructions in a form of software. The processor 1510 is a general-purpose processor, a digital signal processor (digital signal processor, DSP), an ASIC, a field-programmable gate array (field-programmable gate array, FPGA) or another programmable logic device, a discrete gate or a transistor logic device, or a discrete hardware component. The processor implements or performs the methods, the steps, and logical block diagrams that are disclosed at least one embodiment. The general-purpose processor is a microprocessor, or the processor is a digital signal processor, microcontroller, or other type or processing device. The steps of the methods disclosed with reference to at least one embodiment are directly performed and completed by a hardware decoding processor, or is performed and completed by using a combination of hardware and software modules in the decoding processor. A software module is located in a mature storage medium in the art, such as a random access memory, a flash memory, a read-only memory, a programmable read-only memory, an electrically erasable programmable memory, or a register. The storage medium is located in the memory 1540, and the processor 1510 reads information in the memory 1540 and completes the steps in the foregoing methods in combination with hardware of the processor 1510.

In at least one embodiment, the communication interface 1530 is configured to perform receiving and sending steps of the data management apparatus in the embodiments shown in FIG. 1 or FIG. 3. The processor 1510 is configured to perform a processing step of the data management apparatus in the embodiments shown in FIG. 1 or FIG. 3.

The communication unit is a communication interface of the apparatus, and is configured to receive a signal from another apparatus. For example, when the apparatus is implemented in a chip manner, the transceiver unit is a communication interface used by the chip to receive a signal from another chip or apparatus or send a signal to another chip or apparatus.

According to one aspect, a computer-readable storage medium is provided. The computer-readable storage medium stores instructions. When the instructions are run, functions of the data management apparatus in FIG. 1 to FIG. 3 are implemented.

According to at least one embodiment, a computer program product including instructions is provided. The computer program product includes the instructions. When the instructions are run, functions of the data management apparatus in FIG. 1 to FIG. 3 are implemented.

According to at least one embodiment, a chip is provided. The chip is used in a data management apparatus. The chip includes at least one processor and a communication interface. The communication interface is coupled to the at least one processor, and the processor is configured to run instructions, to implement functions of the data management apparatus in FIG. 1 to FIG. 3.

In at least one embodiment, software, hardware, firmware, or any combination thereof is used. When software is used, at least one embodiment is implemented in a form of a computer program product. The computer program product includes one or more computer programs or instructions. When the computer programs or instructions are loaded and executed on a computer, the procedures or functions in at least one embodiment are performed. The computer is a general-purpose computer, a dedicated computer, a computer network, a network device, user equipment, or another programmable apparatus. The computer programs or the instructions is stored in a computer-readable storage medium, or is transmitted from a computer-readable storage medium to another computer-readable storage medium. For example, the computer programs or the instructions is transmitted from a website, computer, server, or data center to another website, computer, server, or data center in a wired or wireless manner. The computer-readable storage medium is any usable medium accessible by a computer, or a data storage device, such as a server or a data center, integrating one or more usable media. The usable medium is a magnetic medium, for example, a floppy disk, a hard disk, or a magnetic tape, is an optical medium, for example, a digital video disc (digital video disc, DVD), or is a semiconductor medium, for example, a solid-state drive (solid-state drive, SSD).

A person skilled in the art understands and implements another variation according to at least one embodiment by viewing the accompanying drawings, disclosed content, and the appended claims. In the claims, the term “comprising” (comprising) does not exclude another component or another step, and “a” or “one” does not exclude a meaning of plurality. A single processor or another unit implements several functions enumerated in the claims. Some measures are recorded in varying dependent claims, but this does not mean that these measures cannot be combined to produce a great effect.

At least one embodiment is described with reference to specific features described herein, various modifications and combinations are made to them without departing from the spirit and scope of the embodiments described herein. Correspondingly, the specification and the accompanying drawings are merely example descriptions defined by the appended claims, and are considered as modifications, variations, combinations or equivalents that cover the scope of at least one embodiment described herein. A person skilled in the art makes various modifications and variations according to at least embodiment without departing from the spirit and scope of embodiments described herein. In this way, at least one embodiment is intended to cover these modifications and variations provided that they fall within the scope of the claims and their equivalent technologies.

What is claimed is:

1. A method, wherein the method comprises:
obtaining from memory, by a processor, first service data, first authorization information, and a first source file;
determining, by the processor, a first association relationship between the first service data and the first authorization information based on a second association relationship between the first source file and the first authorization information, wherein the first service data is data obtained from the memory based on the first source file; and
managing, by the processor, the first service data based on the first authorization information.

2. The method according to claim 1, wherein the first authorization information includes available time information.

3. The method according to claim 2, wherein the managing the first service data based on the first authorization information includes:
determining, based on the available time information, whether to delete the first service data or configure the first service data to be inaccessible.

4. The method according to claim 1, wherein the first authorization information includes use permission information, the use permission information is used to indicate a range in which the first service data is legally used.

5. The method according to claim 4, wherein the use permission information includes one or more information: region information, platform information or usage information.

6. The method according to claim 1, wherein the first authorization information includes an authorization identifier or basic information of an authorizer.

7. The method according to claim 1, wherein the first authorization information includes use permission information, the use permission information is used to indicate a range in which the first service data is legally used, and wherein the managing the first service data based on the first authorization information includes:
determining, based on the use permission information, whether to send the first service data to a target location.

8. The method according to claim 1, wherein the method further comprises:
establishing an association relationship between the first service data and information about a data processor of the first service data.

9. The method according to any claim 1, wherein the method further comprises:
establishing an association relationship between the first service data and information about a subscriber of the first service data.

10. An apparatus, wherein the apparatus comprises:
at least one processor;
one or more memories coupled to the at least one processor and storing instruction which when executed by the at least one processor, cause the apparatus to:
obtaining from the one or more memories first service data, first authorization information, and a first source file;
determining an association relationship between the first service data and the first authorization information based on an association relationship between the first source file and the first authorization information, wherein the first service data is data obtained based on the first source file; and
managing the first service data based on the first authorization information.

11. The apparatus according to claim 10, wherein the first authorization information includes available time information.

12. The apparatus according to claim 11, wherein the instructions executed by the at least one processor to further cause the apparatus to:
determine, based on the available time information, whether to delete the first service data or configure the first service data to be inaccessible.

13. The apparatus according to claim 10, wherein the first authorization information includes use permission information, the use permission information is used to indicate a range in which the first service data is legally used.

14. The apparatus according to claim 13, wherein the use permission information includes one or more information: region information, platform information or usage information.

15. The apparatus according to claim 13, wherein the instructions executed by the at least one processor to further cause the apparatus to:
determine, based on the use permission information, whether to send the first service data to a target location.

16. The apparatus according to claim 10, wherein the instructions executed by the at least one processor to further cause the apparatus to:
establish an association relationship between the first service data and information about a data processor of the first service data.

17. The apparatus according to claim 10, wherein the instructions executed by the at least one processor to further cause the apparatus to:
establish an association relationship between the first service data and information about a subscriber of the first service data.

18. A non-transitory storage medium storing a program, which when executed by one or more processors, cause the one or more processors to perform operations, the operations comprising:
obtaining from memory first service data, first authorization information, and a first source file;
determining an association relationship between the first service data and the first authorization information based on an association relationship between the first source file and the first authorization information, wherein the first service data is data obtained from the memory based on the first source file; and
managing the first service data based on the first authorization information.

19. The non-transitory storage medium according to claim 18, wherein the first authorization information includes use permission information, the use permission information is used to indicate a range in which the first service data is legally used.

20. The non-transitory storage medium according to claim 19, wherein the use permission information includes one or more information: region information, platform information or usage information.
